(19) United States
(12) Patent Application Publication
(10) Pub. No.: US 2010/0020271 A1
(43) Pub. Date: Jan. 28, 2010

(54) Liquid crystal display panel

(75) Inventors: Huang-Shen Lin, Miao-Li (TW); Kuan-Hsiung Wang, Miao-Li (TW); Chih-Sheng Chang, Miao-Li (TW); Chuen-Ju Chen, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/459,256

(22) Filed: Jun. 29, 2009

(30) Foreign Application Priority Data
Jul. 27, 2008 (CN) 200810068075.8

(51) Int. Cl. G02F 1/1347; G02F 1/1333

(52) U.S. Cl. 349/75; 349/84

(57) ABSTRACT

A liquid crystal display (LCD) panel includes a first substrate, a second substrate opposite to the first substrate, and a liquid crystal layer sandwiched between the first and second substrates. The first substrate includes a first wide view film and the second substrate includes a second wide view film. Angles of the first wide film, second wide film, and twist angles of liquid crystal molecules of the liquid crystal layer are defined.

### BACKGROUND

1. Technical Field

The present disclosure relates to a liquid crystal display (LCD) panel.

2. Description of Related Art

Normally, a driving method of liquid crystal molecules in an LCD panel employs a twisted-nematic driving mode. However, viewing angle of the LCD panel using the twisted-nematic driving mode is limited, with display quality impaired by color distortion and gray level inversion when viewed from a wide angle. To augment the viewing angle of a twisted-nematic LCD panel, various techniques are applied, among which the use of Wide View Film (WVF) is extensively adopted.

Referring to FIG. 8, a commonly used LCD panel 100 includes a first substrate 110, a second substrate 120 opposite thereto, and a liquid crystal layer 130 sandwiched between the first substrate 110 and the second substrate 120. The first substrate 110 includes a first alignment film 111, a first wide view film 113 and a first polarizer 115, sequentially mounted apart from the liquid crystal layer 130. The second substrate 120 includes a second alignment film 121, a second wide view film 123 and a second polarizer 125, sequentially mounted apart from the liquid crystal layer 130. The first alignment film 111 includes a first alignment axis A1, and the second alignment film 121 includes a second alignment axis A2. The first wide view film 113 includes a first wide view axis W1, and the second wide view film 123 includes a second wide view axis W2. The first polarizer 115 includes a first polarization axis P1, and the second polarizer 125 includes a second polarization axis P2.

Referring to FIG. 9, the first alignment axis A1 and the second alignment axis A2 are mutually perpendicular. Liquid crystal molecules of the liquid crystal layer 130, subjected to the effect of the first alignment film 111 and the second alignment film 121, exhibit a twisted-nematic alignment having a twist angle θ3, 90°. A horizontal axis X parallel to the LCD panel and a vertical axis Y perpendicular to the LCD panel 100 are defined. The angle between the first alignment axis A1 and the horizontal axis X and the angle between the second alignment axis A2 and the horizontal axis X are both 45°. The first wide view axis W1 coincides with the first alignment axis A1, and the second wide view axis W2 coincides with the second alignment axis A2. The first polarization axis P1 coincides with the first alignment axis A1, and the second polarization axis P2 coincides with the second alignment axis A2.

The first wide view film 113 and the second wide view film 123 are both discotic liquid crystal films and increase the viewing angle of the LCD panel 100 and enhance the contrast ratio. Referring to FIG. 10, the discotic liquid crystal film includes a plurality of discotic liquid crystal molecules sequentially aligned along the vertical axis Y. Along the direction of the vertical axis Y, the angles between the plural discotic crystal liquid molecules and the horizontal axis X are β1, β2, β3, . . . respectively, and the angles β1, β2, β3, . . . comply with the rule β1<β2<β3< . . . . As the discotic liquid crystal molecules perform optical compensation respectively to liquid crystal molecules with different orientation in the liquid crystal layer 130, the discotic liquid crystal molecule film can augment the viewing angle of the LCD panel 100 and enhance the contrast ratio.

Usually, a major parameter for evaluating the compensation characteristic of the two wide view films 113, 123 is an average angle βi of the angles β1, β2, β3, . . . between all the discotic liquid crystal molecules and the horizontal axis X. When βi is a predetermined value 130, the two wide view films 113, 123 can provide the optimal optical compensation to the liquid crystal molecules in the liquid crystal layer 130. For example, when the liquid crystal layer 130 exhibits a twist angle θ3 of about 90°, the optimal optical compensation of the liquid crystal layer 130 can be obtained normally when the average angle βi of the two wide view films is 17°.

Due to limitations of the manufacturing process, the average angle βi of the two wide view films 113, 123 does not easily equal the predetermined value β0 and differs from the predetermined value β0 by an error value. Therefore, the error value is ignored and all parts of the LCD panel 100 are mounted sequentially in accordance with the aforementioned axial alignment and θ1+θ2+θ3 =180°, the first wide view film 113 and the second wide view film 123 are restricted in the optical compensation provided to the liquid crystal molecules in the liquid crystal layer 130. This leads to limited improvements from the first wide view film 113 and the second wide view film 123 for the viewing angle and contrast ratio of the LCD panel 100, and display quality of the LCD panel 100 is impaired.

Accordingly, what is needed is an LCD panel that can overcome the described limitations.

### BRIEF DESCRIPTION OF THE DRAWINGS

FIG. 1 is a perspective exploded view of a first embodiment of an LCD panel in accordance with the present disclosure.

FIG. 2 is a structural view of a discotic liquid crystal film of FIG. 1.

FIG. 3 is an axial view of all parts of the LCD panel in FIG. 1.

FIG. 4 is an axial view of all parts of a second embodiment of an LCD panel in accordance with the present disclosure.

FIG. 5 is an axial view of all parts of a third embodiment of an LCD panel in accordance with the present disclosure.

FIG. 6 is an axial view of all parts of a fourth embodiment of an LCD panel in accordance with the present disclosure.

FIG. 7 is a perspective exploded view of a fifth embodiment of an LCD panel in accordance with the present disclosure.

FIG. 8 is a perspective exploded view of a commonly used LCD panel.

FIG. 9 is an axial view of all parts of the LCD panel shown in FIG. 8.

FIG. 10 is a structural view of a discotic liquid crystal film of the LCD panel.

### DETAILED DESCRIPTION

Referring to FIG. 1, an LCD panel 200 includes a first substrate 210, a second substrate 220 opposite to the first substrate 210, and a liquid crystal layer 230 sandwiched between the first substrate 210 and the second substrate 220. The first substrate 210 includes a first alignment film 211, a first wide view film 213 and a first polarizer 215, sequentially mounted apart from the liquid crystal layer 230. The second substrate 220 includes a second alignment film 221, a second wide view film 223 and a second polarizer 225, sequentially mounted apart from the liquid crystal layer 230. The liquid crystal layer 230 includes a plurality of liquid crystal molecules (not shown).

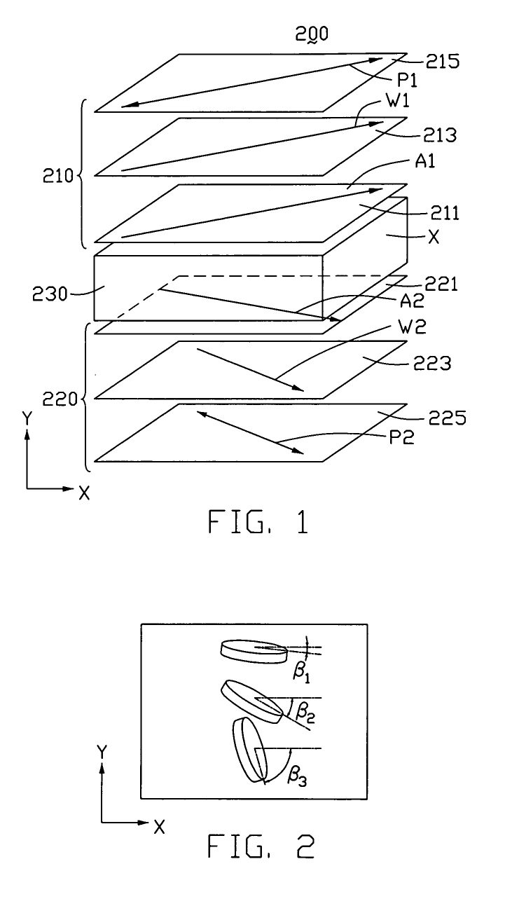

The first wide view film 213 and the second wide view film 223 are both discotic liquid crystal films augmenting the viewing angle of the LCD panel 200 and enhancing the contrast ratio, and both include a plurality of discotic liquid crystal molecules. Referring to FIG. 2, a horizontal axis parallel to the LCD panel 200 and a vertical axis Y perpendicular to the LCD panel 200 are defined. The discotic liquid crystal film includes a plurality of discotic liquid crystal molecules, sequentially mounted along the vertical axis Y. The angles between the plural discotic liquid crystal molecules and the horizontal axis X are β1, β2, β3, . . . respectively, and the angles β1, β2, β3, . . . comply with the rule β1<β2<β3< . . . .

An average angle βi of the angles β1, β2, β3, . . . between all the discotic liquid crystal molecules of the two wide view films 213, 223 and the horizontal axis X is predetermined. A predetermined value β0, considered as an average angle of the wide view film to perform the optimal optical compensation to a liquid crystal layer with a twist angle 90°, is defined. In accordance with the predetermined value β0, an error value φ of the two wide view films 213, 223 is defined to be the difference of the predetermined value β0 and the average angle βi, where −5°≦φ≦5° and φ≠0. When φ=0, the error value of the two wide view films 213, 223 is zero.

For example, when the predetermined value β0 is 17° and the average angle βi of the two wide view films 213, 223 is 16°, the error value φ=β0−βi=1°; when the predetermined value β0 is 17° and the average angle βi of the two wide view films 213, 223 is 18°, the error value φ=β0−βi=−1°.

The first alignment film 211 includes a first alignment axis A1, and the second alignment film 221 includes a second alignment axis A2. The first wide view film 213 includes a first wide view axis W1, and the second wide view film 223 includes a second wide view axis W2. The first polarizer 215 includes a first polarization axis P1, and the second polarizer 225 includes a second polarization axis P2.

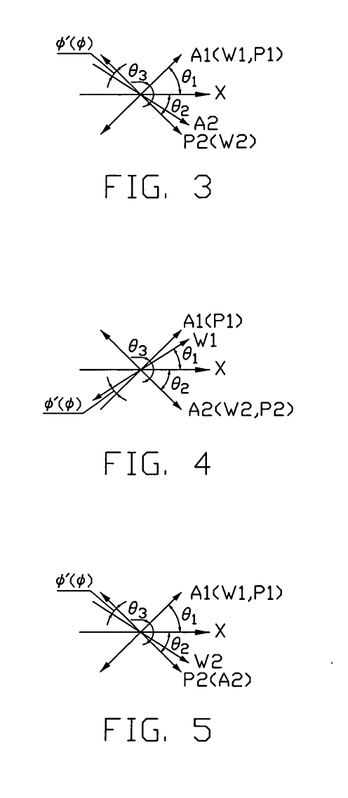

Together with the reference to FIG. 3, an angle (indicating an acute angle) between the first wide view axis W1 and the horizontal axis X is θ1, and an angle (indicating an acute angle) between the second wide view axis W2 and the horizontal axis X is θ2. An alignment angle between the first alignment axis A1 and the second alignment axis A2 is θ3, i.e. a twisted-nematic alignment having a twist angle θ3, while the liquid crystal molecules of the liquid crystal layer 230 are subject to the effect of the first alignment film 211 and the second alignment film 221.

It should be noted that an angle (indicating an acute angle) between the first alignment axis A1 and the horizontal axis X is θ4 (not shown), an angle (indicating an acute angle) between the second alignment axis A2 and the horizontal axis X is θ5 (not shown), an angle (indicating an acute angle) between the first alignment axis A1 and the first wide view axis W1 is θ6 (not shown), and an angle (indicating an acute angle) between the second alignment axis A2 and the first wide view axis W2 is θ7 (not shown).

Among all the angles, 40°≦θ1≦50°, 40°≦θ2≦50°, 85°≦θ3≧95°, 85°≦θ1+θ2≦95°, 40°≦θ4≦50°, 40°≦θ5≦50°, 0°≦θ6≦10°, 0°≦θ7≦10° and θ4+θ5=θ3. θ1, θ2 and θ3 comply with the formula: θ1+θ2+θ3=180°+φ′, where φ′ defines a correction value.

When φ′ is negative, 2φ<φ′<0, and when φ′ is positive, 0<φ′<2φ, that is, 0°<|φ′|≦|2φ|. Preferably, when φ′ is negative, φ<φ′<0, and when φ′ is positive, 0<φ′<φ, that is, 0°<|φ′|≦|φ|.

In an embodiment, the θ1, θ2 and θ4 are all 45°, θ6 is 0°, θ7 is 1°, and φ′=φ=−1°. According to the previously stated formula, θ3=180°+φ−θ1+θ2=90°+φ=89°, and θ5=θ3−θ4=44°.

The first polarization axis P1 is perpendicular to the second polarization axis P2. An angle between the first polarization axis P1 and the horizontal axis X and an angle between the second polarization axis P2 and the horizontal axis X are both 45°. Consequently, the first polarization axis P1 coincides with the first wide view axis W1 and the first alignment axis A1, and the second polarization axis P2 coincides with the second wide view axis W2.

Compared with the related art, when the error value φ in the two wide view films 213, 223 of the LCD panel 200 in the present disclosure is −1°, the alignment angle θ3 between the first alignment axis A1 and the second alignment axis A2, that is, the twist angle θ3 of the liquid crystal molecules in the liquid crystal layer 230 is set to 90°+φ=89°. Because the change of the twist angle θ3 of the liquid crystal molecules in the liquid crystal layer 230 further generates compensation on the error value φ, this enables the two wide view films 213, 223 to provide better optical compensation to the liquid crystal molecules of the liquid crystal layer 230, thereby improving the display quality of the LCD panel 200.

Referring to FIG. 4, a second embodiment of an LCD panel in accordance with the present disclosure differs from the LCD panel 200 of the first embodiment in that the twist angle θ3 of the liquid crystal molecules in the liquid crystal layer is 90°, the angle θ2 between the second alignment axis A2 and the horizontal axis X is 45°, and the angle θ1 between the first alignment axis A1 and the horizontal axis X=180°+φ′−(θ2+θ3)=180°+φ−(θ2+θ3). That is to say, all parameters comply with the formula θ1+θ3=135°+φ′=135°+φ or θ1=45°+φ=44°.

By changing the angle θ1 between the first wide view axis W1 and the horizontal axis X to perform a corresponding compensation on the error value φ, the LCD panel of the embodiment enables the two wide view films to provide better optical compensation on the liquid crystal molecules of the liquid crystal layer, thereby providing better display quality of the LCD panel.

Referring to FIG. 5, an LCD panel of a third embodiment of an LCD panel in accordance with the present disclosure differs from the LCD panel 200 of the first embodiment in that the twist angle θ3 of the liquid crystal molecules in the liquid crystal layer is 90°, the angle θ1 between the first alignment axis A1 and the horizontal axis X is 45°, and the angle θ2 between the second alignment axis A2 and the horizontal axis X=180°+φ′−(θ1+θ3)=180°+φ−(θ1+θ3). That is to say, all parameters comply with the formula θ1+θ3=135°+φ′=135°+φ or θ1=45°+φ=44°.

By changing the angle θ2 between the second wide view axis W2 and the horizontal axis X to perform a corresponding compensation on the error value φ, the LCD panel of the present embodiment enables the two wide view films to provide better optical compensation on the liquid crystal molecules of the liquid crystal layer, thereby providing better display quality of the LCD panel.

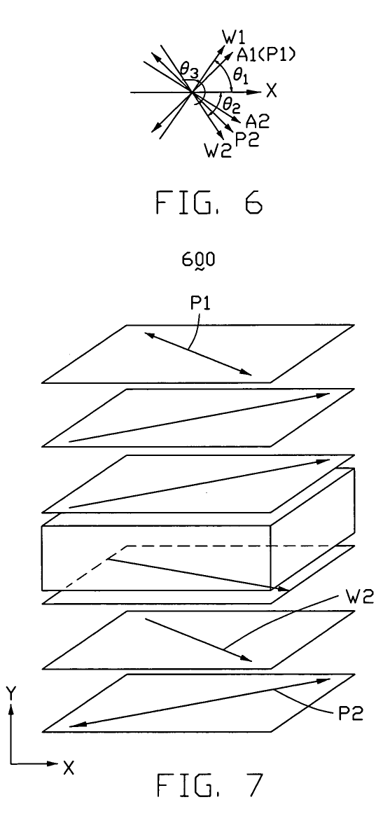

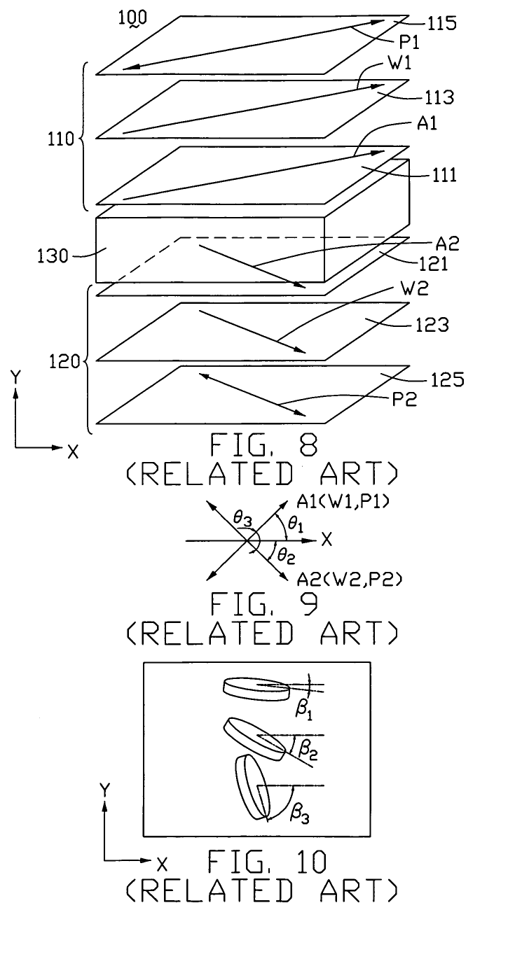

Referring to FIG. 6, an LCD panel of a fourth embodiment of an LCD panel in accordance with the present disclosure differs from the LCD panel 200 of the first embodiment in that φ=φ′=1°, θ1=θ2=46°, θ3=89°, θ4=45°, θ5=44°, θ6=1°, and θ7=1°.

The values θ1, θ2, and θ3 in the LCD panel of the present embodiment comply with the formula: θ1+θ2+θ3=180°+φ′, and the display quality thereof is enhanced by varying the θ1, θ2, and θ3 to perform a corresponding compensation on the error value φ.

Referring to FIG. 7, a fifth embodiment of an LCD panel in accordance with the present disclosure differs from the LCD panel 200 of the first embodiment in that the first polarization axis P1 coincides with the second wide view axis W1, and the second polarization axis P2 coincides with the first wide view axis W2.

The LCD panel of the present disclosure also includes other forms of different designs, for example, when the θ1, θ2, and θ3 are within acceptable ranges and comply with the formula: θ1+θ2+θ3=180°+φ′, the change to any two parameters or all of the θ1, θ2, and θ3 enables compensation on the error value φ to improve the display quality of the LCD panel. Moreover, an LCD panel using a wide view film only and having the wide view film with an error value φ, satisfies the formula: θ1+θ3=135°+φ′ by adjusting the angle θ1 between the wide view axis of the wide view film and the horizontal axis and the twist angle θ3 of the liquid crystal molecules in the liquid crystal layer to make compensation on the error value φ. It is noteworthy that the correction value φ′ completely compensates the error value when φ′=φ, so that the LCD panel can further attain the optimal compensation result. However, the correction value φ′ also may not equal φ. In that case, the conditions that 2φ<φ′<0 when φ is negative, and 0<φ′<2φ when φ is positive are met, such that compensation to a certain extent is conducted on the correction value φ′ or on the error value φ is allowed. In comparison with the LCD panel of the related art, the display quality of the LCD panel of the present disclosure is further improved.

It is to be, further, understood that even though numerous characteristics and advantages of the present embodiments include been set forth in the foregoing description with details of the structures and functions of the embodiments, the disclosure is illustrative only, and changes made in detail, especially in matters of shape, size, and arrangement of parts, within the principles of the embodiments, to the full extent indicated by the broad general meaning of the terms in which the appended claims are expressed.

What is claimed is:

1. A liquid crystal display (LCD) panel, comprising:
a first substrate comprising a first wide view film with a first wide view axis;
a second substrate opposite to the first substrate comprising a second wide view film with a second wide view axis;
a liquid crystal layer sandwiched between the first substrate and the second substrate;
a horizontal axis being parallel to the LCD panel;
wherein θ1+θ2+θ3=180°+φ′ and 0°<|φ′≦|2φ|, wherein φ′ is a correction value to correct an error value φ; wherein φ is a difference value between a predetermined value and the average angle of the first and second wide view film, wherein φ≠0;
wherein θ1 is a first angle between the first wide view axis of the first wide view film and the horizontal axis;
wherein θ2 is a second angle between the second wide view axis of the second wide view film and the horizontal axis; and
wherein θ3 is a twist angle for liquid crystal molecules of the liquid crystal layer.

2. The LCD panel of claim 1, wherein the average angle between the first and second wide view films and the horizontal axis is an average value of angles between all discotic liquid crystal molecules of the first and second wide view films and the horizontal axis.

3. The LCD panel of claim 1, wherein the average angle of the first and second wide view films to perform a optimal optical compensation to a liquid crystal layer with a twist angle 90° is a predetermined angle.

4. The LCD panel of claim 1, wherein
2φ<φ′<0, if φ is negative; and
0<φ′<2φ, if φ is positive.

5. The LCD panel of claim 1, wherein
φ<φ′<0 if φ is negative; and
0<φ′<φ if φ is positive.

6. The LCD panel of claim 1, wherein φ′=φ.

7. The LCD panel of claim 1, wherein 0°≦θ1≦50°, 40°≦θ2≦50°, and 85°≦θ3≦95°.

8. The LCD panel of claim 1, wherein the first substrate further comprises a first alignment film, and the second substrate further comprises a second alignment film, the first and second alignment films aligning the liquid crystal molecules of the liquid crystal layer.

9. The LCD panel of claim 8, wherein a first alignment angle between a first alignment axis of the first alignment film and the horizontal axis is θ4, a second alignment angle between a second alignment axis of the second alignment film and the horizontal axis is θ5, and the twist angle θ3=θ4+θ5.

10. The LCD panel of claim 9, wherein 0°≦θ4≦50°, and 40°≦θ5≦50°.

11. The LCD panel of claim 9, wherein an angle between the first alignment axis of the first alignment film and the first wide view axis of the first alignment film is θ6, and 0°≦θ6≦10°.

12. The LCD panel of claim 9, wherein an angle between the second alignment axis of the second alignment film and the second wide view axis of the second alignment film is θ7, and 0°≦θ7≦10°.

13. The LCD panel of claim 1, wherein the first wide view film and the second wide view film are both discotic liquid crystal films.

14. A liquid display (LCD) panel, comprising:
a liquid crystal layer having a plurality of liquid crystal molecules; and
a wide view film having a wide view axis;
a horizontal axis being parallel to the LCD panel and having a plurality of discotic liquid crystal molecules, wherein θ1+θ3=135°+φ′, and 0°<|φ′|≦|2φ|, wherein φ′ is a correction value to correct the error value φ;
wherein φ is a difference value between a predetermined value and the average angle of the wide view film, wherein φ≠0;
wherein θ1 is a first angle between the wide view axis of the wide view film and the horizontal axis;
wherein θ3 is a twist angle for liquid crystal molecules of the liquid crystal layer.

15. The LCD panel of claim 14, wherein the average angle between the wide view films and the horizontal axis is an average value of angles between all discotic liquid crystal molecules of the wide view films and the horizontal axis.

16. The LCD panel of claim 14, wherein
2φ<φ′<0, if φ is negative; and
0<φ′<2φ, if when φ is positive.

17. The LCD panel of claim 14, wherein the average angle between the wide view films and the horizontal axis is an average value of angles between all discotic liquid crystal molecules of the wide view films and the horizontal axis.
φ<φ′<0, if φ is negative; and
0<φ′<φ, if φ is positive.

18. The LCD panel of claim 14, wherein φ′=φ.

19. The LCD panel of claim 14, wherein 0°≦θ1≦50°, and 85°≦θ3≦95°.

20. The LCD panel of claim 14, wherein the LCD panel further comprises a first alignment film and a second alignment film, wherein the first and second alignment films are used to align the liquid crystal molecules of the liquid crystal layer, and a first alignment angle between a first alignment axis of the first alignment film and the horizontal axis is θ4, a second alignment angle between a second alignment axis of the second alignment film and the horizontal axis is θ5, and the twist angle θ3=θ4+θ5.
